(19) United States
(12) Patent Application Publication
(10) Pub. No.: US 2002/0036557 A1
(43) Pub. Date: Mar. 28, 2002

(54) Electromagnetic relay

(75) Inventors: Akihiko Nakamura, Tokyo (JP); Shigemitsu Aoki, Tokyo (JP); Yoshio Okamoto, Tokyo (JP); Tomohisa Endoh, Tokyo (JP)

Correspondence Address: STAAS & HALSEY LLP, 700 11TH STREET, NW, SUITE 500, WASHINGTON, DC, 20001, US

(73) Assignee: Fujitsu Takamisawa Component limited, Tokyo (JP)

(21) Appl. No.: 09/903,614

(22) Filed: Jul. 13, 2001

(30) Foreign Application Priority Data
Jul. 18, 2000 (JP) 2000-222401
Dec. 8, 2000 (JP) 2000-374314

(51) Int. Cl. H01H 67/02

(52) U.S. Cl. 335/128

(57) ABSTRACT

An electromagnetic relay of a simple structure for reliably making and breaking a high load voltage is provided.

First and second fixed contact terminals are mounted on a plastic base block. First and second branched moving pieces are attached to the lower side of a hanging portion of a spring member. When a coil has not been excited, the first and second moving pieces come into contact with a back-stop plate away from the first and second fixed contact elements and will not be conductive. When the coil is excited, contact elements attached to the first and second moving pieces come into contact with the contact elements attached to the first and second fixed contact elements to provide conduction between the first fixed contact terminal and the second fixed contact terminal.

### BACKGROUND OF THE INVENTION

1. Field of the Invention The present invention relates to an electromagnetic relay.

2. Description of the Related Art

An electromagnetic relay is used for making and breaking a load voltage. In order to reliably make and break high load voltages, however, attempts have been made to open and close the contact point by using a motor as disclosed in Japanese Unexamined Patent Publication (Kokai) No. 65685/1995. However, the device of the above publication has a complex structure and is expensive. It has therefore been attempted to connect plural electromagnetic relays each having a pair of contact terminals in series (see FIG. 18) or to connect the contact terminals in series inside an electromagnetic relay that has plural contact terminals (see FIG. 19).

Even in the above-mentioned case, however, defects are involved such as an increased number of steps for forming wiring to make a connection among plural connection terminals, an increase in the length of current-flow path in the relay which generates greater heat, and use of plural electromagnetic relays or of an electromagnetic relay having plural contact terminals which drives up the cost and makes it difficult to decrease the size.

### SUMMARY OF THE INVENTION

In view of the above-mentioned problems, it is an object of the present invention to provide a relay of a simple structure capable of reliably making and breaking high load voltages.

According to the present invention, there is provided an electromagnetic relay which comprises

a first fixed contact terminal and a second fixed contact terminal spaced from each other on one surface of a base block,

fixed conductor pieces, in a number n−1, mounted on said one surface of said base block in alignment with and between the first fixed contact terminal and the second fixed contact terminal, and

moving conductor pieces, in a number n, formed by or supported by cantilevered spring members that are simultaneously moved by one or plural coils mounted on said base block, for connecting the first fixed contact terminal, the second fixed contact terminal and the two neighboring fixed conductor pieces simultaneously in a crosslinked manner,

wherein the first fixed contact terminal and the second fixed contact terminal are connected together through serially arranged contact sets of a number of 2n formed by the first fixed contact terminal, second fixed contact terminal, fixed conductor pieces of the number of n−1 and moving conductor pieces of the number of n,

while n is an integer of not smaller than 1.

The thus constituted electromagnetic relay realizes the making and breaking of a voltage on a base block through plural serial contact sets.

The present invention may be more fully understood from the description of preferred embodiments of the invention set forth below, together with the accompanying drawings.

### BRIEF DESCRIPTION OF THE DRAWINGS

FIG. 1 is a perspective view of a first embodiment.

FIG. 2 is a side view of the first embodiment.

FIG. 3 is a disassembled view of the first embodiment.

FIG. 4 is a disassembled view of the first embodiment.

FIG. 5 is a diagram illustrating the operation of contact points of the first embodiment.

FIG. 6 is a circuit diagram of the first embodiment.

FIG. 7 is a perspective view of a second embodiment.

FIG. 8 is a side view of the second embodiment.

FIG. 9 is a perspective view of a part of the second embodiment.

FIG. 10 is a perspective view of a part of the second embodiment.

FIG. 11 is a perspective view of a part of the second embodiment.

FIG. 12 is a diagram illustrating the operation of contact points of the second embodiment.

FIG. 13 is a circuit diagram of the second embodiment.

FIG. 14 is a side view of a third embodiment.

FIG. 15 is a side view of a fourth embodiment.

FIG. 16 is a view illustrating the operation of contact points of a fifth embodiment.

FIG. 17a & 17b are view illustrating how to mount the contact elements, wherein FIG. 17a illustrates a case of the present invention, and FIG. 17b illustrates a case according to a prior art;

FIG. 18 is a circuit diagram illustrating a prior art.

FIG. 19 is a circuit diagram illustrating a prior art.

Embodiments of the invention will now be described with reference to the accompanying drawings.

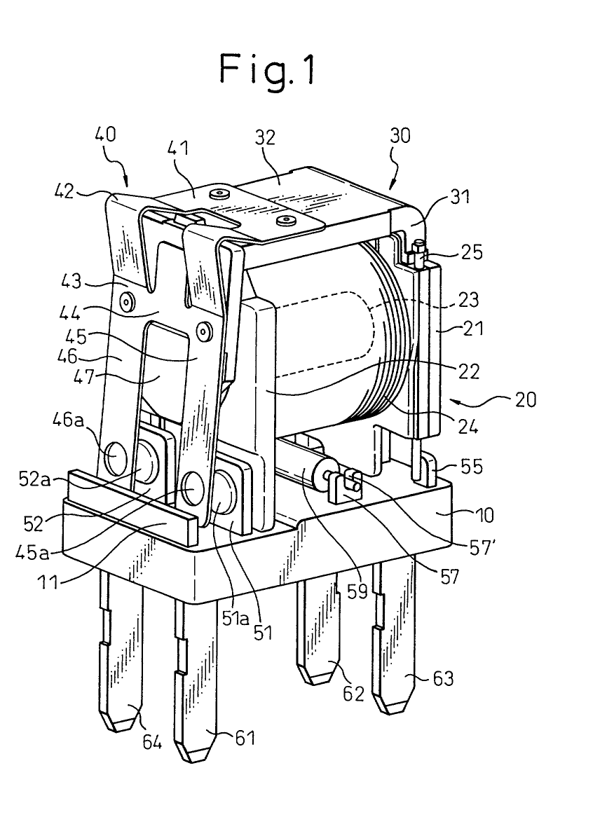

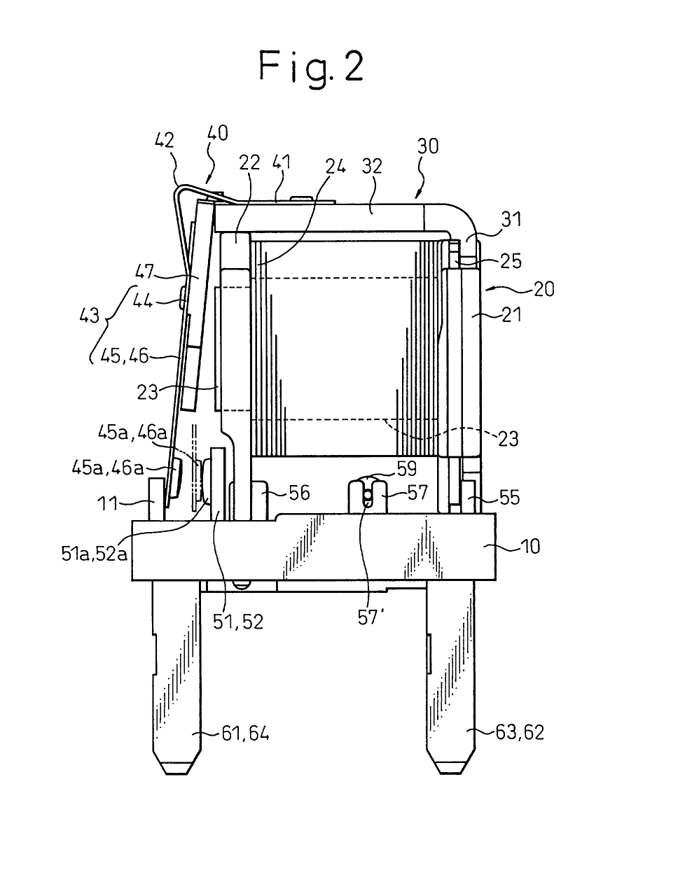

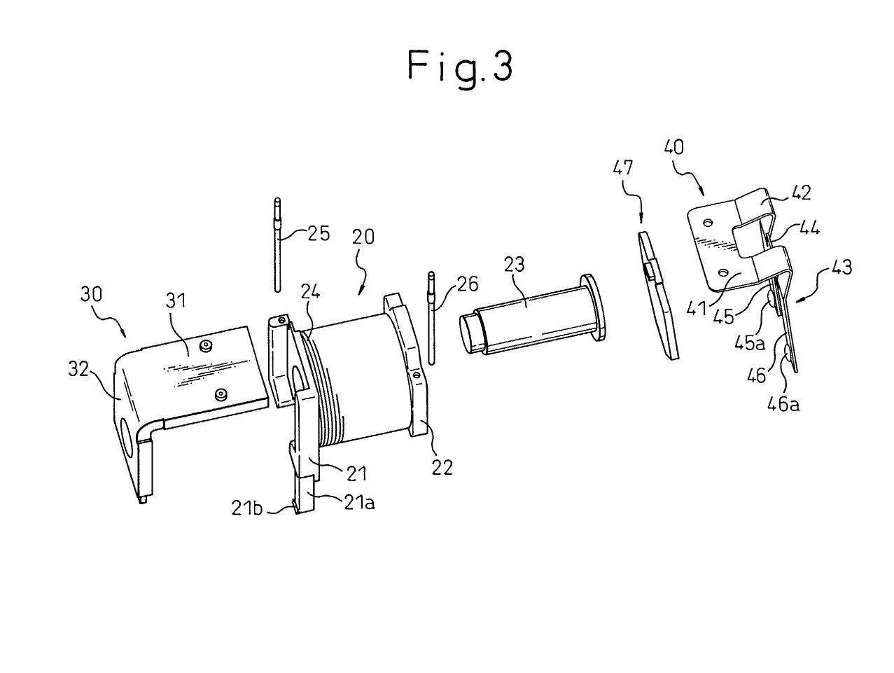

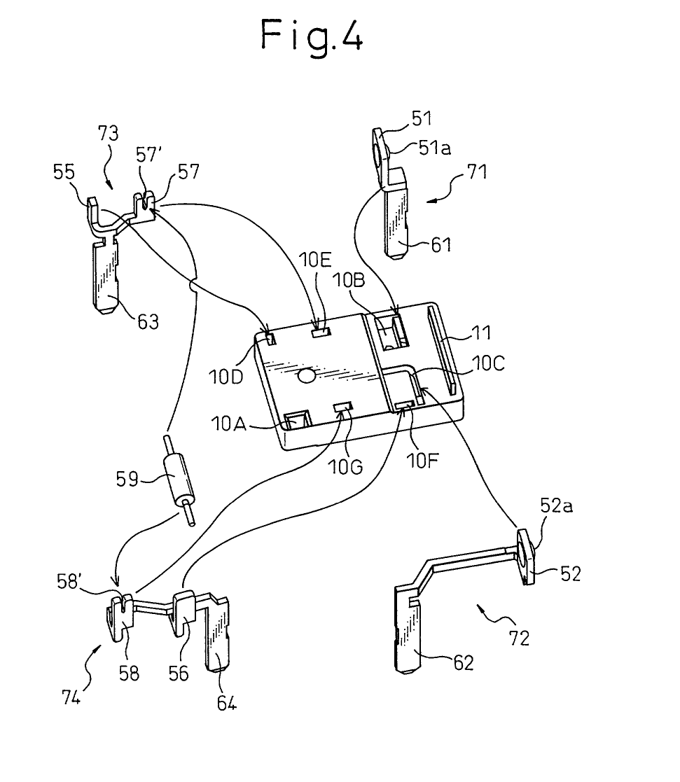

FIG. 1 is a perspective view illustrating a state where a cover is removed from an electromagnetic relay of a first embodiment, FIG. 2 is a side view thereof, and FIGS. 3 and 4 are disassembled views thereof.

Referring to the drawings, a first side wall portion 21 and a second side wall portion 22 of a bobbin 20 are secured to a plastic base block 10, as will be described later, and a vertical portion 31 of an L-type yoke 30 is secured to the first side wall portion 21 of the bobbin 20. A horizontal portion 41 of a spring member 40 is attached by caulking to a horizontal portion 32 of the yoke 30, and a hanging portion 43 continues to the horizontal portion 41 of the spring member 40 via a folded portion 42, the hanging portion 43 extending downward to form a moving conductor piece. An armature 47 made of a magnetic material is attached by caulking to an upper portion 44 of the hanging portion 43.

The lower portion, in a position where the armature 47 is attached to the hanging portion 43 of the spring member 40, is branched into two to form a first moving piece 45 and a second moving piece 46. Though the branched shape is not an absolute requirement, it is possible to set suitable spring constants relying on the branched shape and to accomplish the action with a weak magnetic force and, hence, to decrease the amount of electric power consumed by the coil.

Contact elements 45a, 46a made of a material having an excellent arc-resistance property are attached to the first moving piece 45 and to the second moving piece 46. The back surfaces of the protruded portions of the contact elements 45a and 46a are scraped out to reduce the material cost.

A first fixed contact terminal 51 and a second fixed contact terminal 52 are mounted on the base block 10, and have contact elements 51a and 52a attached thereto. The first fixed contact terminal 51 and the second fixed contact terminal 52 are integrally connected to a first lead terminal 61 and to a second lead terminal 62 which are extending from the lower side of the base block 10 in the drawing and to which the external conductors (not shown) are coupled, in a manner which will be described later.

The bobbin 20 has an iron core 23 arranged on the inside of a cylindrical portion that is not shown, has a coiled conductor 24 wound on the outer side thereof, and forms a coil C together therewith. An end of the coiled conductor 24 is coupled to an upper portion of a conductor pin 25 mounted on a first side wall 21 of the bobbin 20, and a lower end of the conductor pin 25 is contacted to a first coil terminal 55 mounted on the base block 10, the first coil terminal 55 being integrally formed with a third lead terminal 63 which is extending from the lower side of the base block 10 as shown and to which the external conductor (not shown) is coupled, in a manner which will be described later.

Similarly, the other end of the coiled conductor 24 is coupled to an upper portion of a conductor pin 26 (see FIG. 3) mounted on a second side wall 22 of the bobbin 20, a lower end of the conductor pin 26 is contacted to a second coil terminal 56 mounted on the base block 10, the second coil terminal 56 being integrally formed with a fourth lead terminal 64 which is extending from the lower side of the base block 10 as shown and to which the external conductor (not shown) is coupled, in a manner as will be described later.

Further, a third coil terminal 57 having a slot 57a is formed integrally with the third lead terminal 63 and, similarly, a fourth coil terminal 58 having a slot 58a is formed integrally with the fourth lead terminal 64. Both ends of a protector element 59 are attached into the slots 57a, 58a so that an excess current will not flow through the coil C.

When a current is supplied to the third lead terminal 63 and the fourth lead terminal 64 and the coil C is excited, the armature 47 is attracted to the side of the coil C, and the first moving piece 45 and the second moving piece 46 of the spring member 40 move to the side of the coil C, too.

As the coil C is excited and the spring member 40 moves toward the coil C, the contact elements 45a and 46a of the first moving piece 45 and of the second moving piece 46 come into contact with the contact elements 51a, 52a of the first fixed contact terminal 51 and of the second fixed contact terminal 52.

Therefore, when a voltage is applied to, for example, the first lead terminal 61, an electric current flows through; the first lead terminal 61, the first fixed contact terminal 51, the contact element 51a, the contact element 45a, the first moving piece 45, the upper portion 44 of hanging portion 43 of spring member 40, the second moving piece 46, the contact element 46a, the contact element 52a, the second fixed contact terminal 52 and the second lead terminal 62. Thus, the electric current flows through two contact sets, and the time for which the arc continues becomes shorter than that of when a single contact set is employed. When the contact gap is the same as that of the single contact set, therefore, the contact portion exhibits improved durability. When the contact gap is narrowed, the electromagnetic relay consumes less electric power.

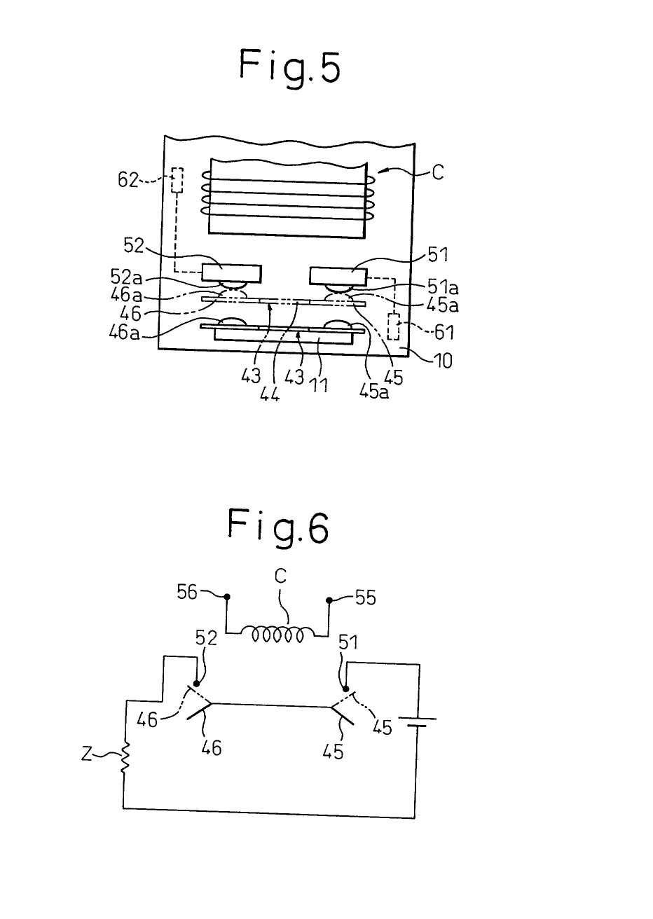

FIG. 5 is a top view schematically illustrating the flow of electricity, and FIG. 6 is a circuit diagram. In FIG. 6, symbol Z denotes a load such as motor.

A back-stop plate 11 is molded with a resin integrally with the base block 10. When the coil C has not been excited, the first moving piece 44 and the second moving piece 45 of the spring member 40 come into contact with the back-stop plate 11 and their positions are determined.

The back-stop plate 11 made of a resin is softened or is melted when the current is not completely broken and heat is generated due to arcing in a state where the first moving piece 45 and the second moving piece 46 are brought into contact with the back-stop plate 11 without exciting the coil C. Then, the first moving piece 45 and the second moving piece 46 move away from the first and second fixed contact terminals 51, 52 due to their own resilient force. Accordingly, the arc ceases and the area of burning does not spread much. When the back-stop plate 11 is formed of a metal, on the other hand, the arc continues to take place because the back-stop plate 11 does not melt, and the area of burning spreads.

A production method according to the first embodiment will be further described with reference to FIGS. 3 and 4.

The conductor pins 25 and 26 for passing an electric current to the coil C are insert-molded in the first side wall 21 and in the second side wall 22 of the bobbin 20.

The bobbin 20 is secured to the base block 10 with its first foot portion 21a formed integrally with the first side wall 21 and second foot portion (not shown) formed integrally with the second side wall 22 being inserted in holes 10A, 10B of the base block 10, and with its pawl 21b formed at the lower end of the first foot portion 21a being engaged with the lower surface of the base block 10.

As described earlier, the first fixed contact terminal 51 is molded integrally with the first lead terminal 61 to thereby form a first fixed contact terminal assembly 71 as shown in FIG. 4. The first fixed contact terminal assembly 71 is secured to the base block 10 with its first fixed contact terminal 51 being so insert-molded as to be located in the hole 10b of the base block 10.

As described earlier, the second fixed contact terminal 52 is formed integrally with the second lead terminal 62 to thereby form a second fixed contact terminal assembly 72 as shown in FIG. 4. The second fixed contact terminal assembly 72 is secured to the base block 10 with its second fixed contact terminal 52 being so insert-molded as to be located in the hole 10b of the base block 10.

As described earlier, the first coil terminal 55 is formed integrally with the third lead terminal 63 and the third coil terminal 57 to thereby form a first coil terminal assembly 73 as shown in FIG. 4. The first coil terminal assembly 73 is secured to the base block 10 with its first coil terminal 55 and third coil terminal 57 being insert-molded so as to be positioned in the holes 10d, 10e of the base block 10.

As described earlier, the second coil terminal 56 is formed integrally with the fourth lead terminal 64 and the fourth coil terminal 58 to thereby form a second coil terminal assembly 74 as shown in FIG. 4. The second coil terminal assembly 74 is secured to the base block 10 with its second coil terminal 56 and fourth coil terminal 58 being insert-molded so as to be positioned in the holes 10f, 10g of the base block 10.

The base block 10 shown in FIG. 4 has not been molded in a shape as described above. From the standpoint of explanation, the base block 10 shown in FIG. 4 shows the mounting positions in a finished state without, however, mounting the terminals.

According to the first embodiment constituted as described above, the electromagnetic relay having two serial contact sets is realized without executing the wiring operation, to suppress the cost, and in a small size.

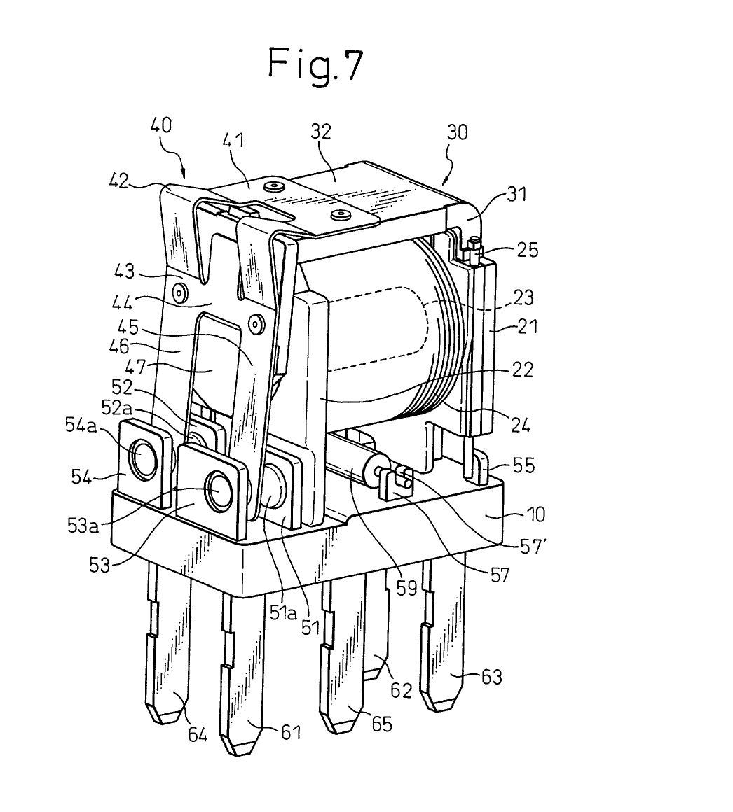

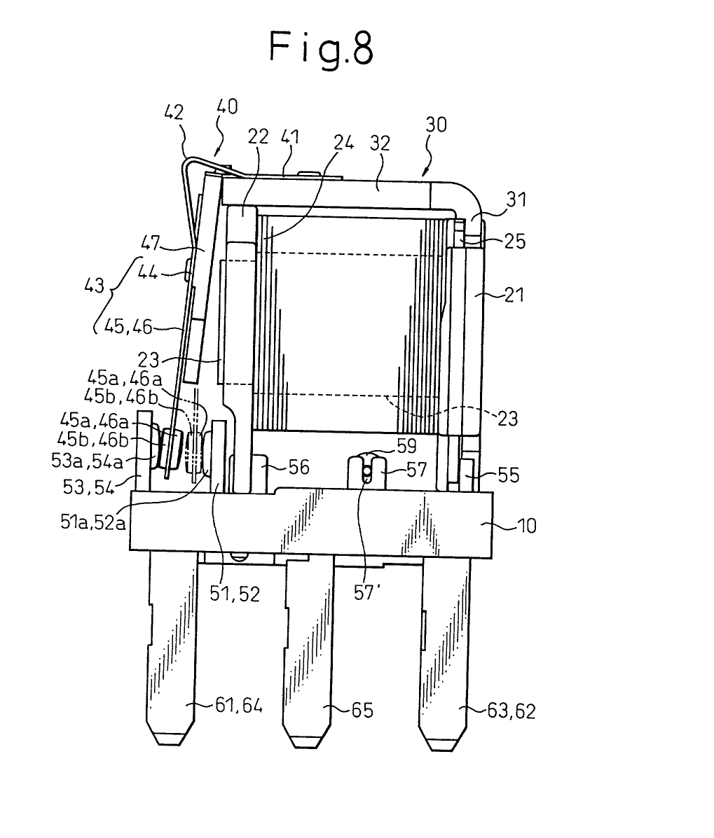

Next, a second embodiment will be described. FIG. 7 is a perspective view of the second embodiment, and FIG. 8 is a side view thereof.

In the second embodiment, a third fixed contact terminal 53 and a fourth fixed contact terminal 54 are disposed facing the first fixed contact terminal 51 and the second fixed contact terminal 52 with the first moving piece 45 and the second moving piece 46 sandwiched therebetween. Contact elements 53a and 54a are attached to the third fixed contact terminal 53 and to the fourth fixed contact terminal 54. Further, contact elements 45b and 46b are attached to the first moving piece 45 and to the second moving piece 46 on the back side of the contact elements 45a and 46a.

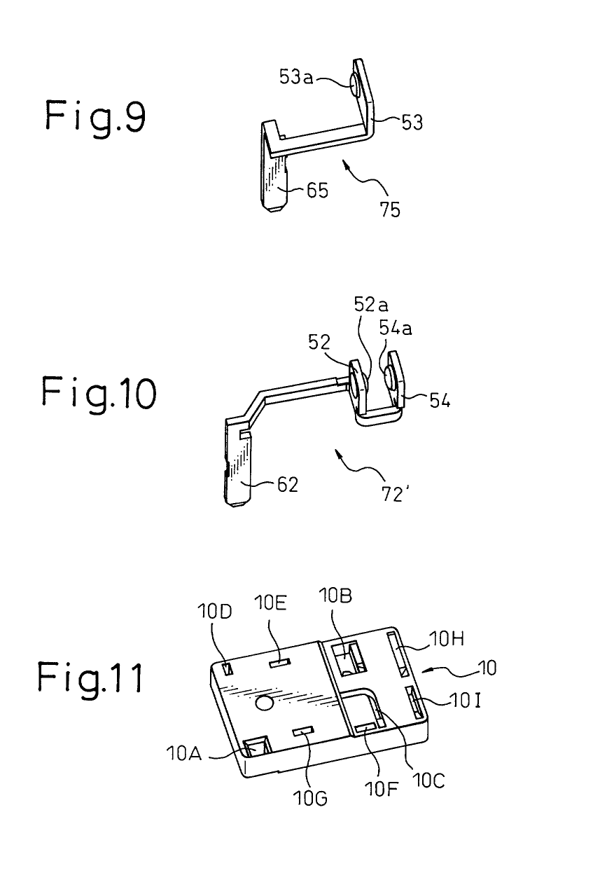

Referring to FIG. 9, the third fixed contact terminal 53 is molded integrally with a fifth lead terminal 65 to form a third fixed terminal assembly 75. Referring to FIG. 10, the fourth fixed contact terminal 54 is formed integrally with the second fixed contact terminal 52 and the second lead terminal 62 to form a second fixed contact assembly 72′.

Holes 10h and 10i are formed in the base block 10. The third fixed contact terminal assembly 75 is so insert-molded that the third fixed contact terminal 53 is positioned in the hole 10h, and the second fixed contact assembly 72′ is so insert-molded that the second fixed contact terminal 52 is positioned in the hole 10b and the fourth fixed contact terminal 54 is positioned in the hole 10i.

The third fixed contact terminal 53 works as a break contact terminal, and the fourth fixed contact terminal 54 works as a common contact terminal. The first fixed contact terminal 51 and the second fixed contact terminal 52 are a make contact terminal and a common contact terminal, respectively, as in the first embodiment.

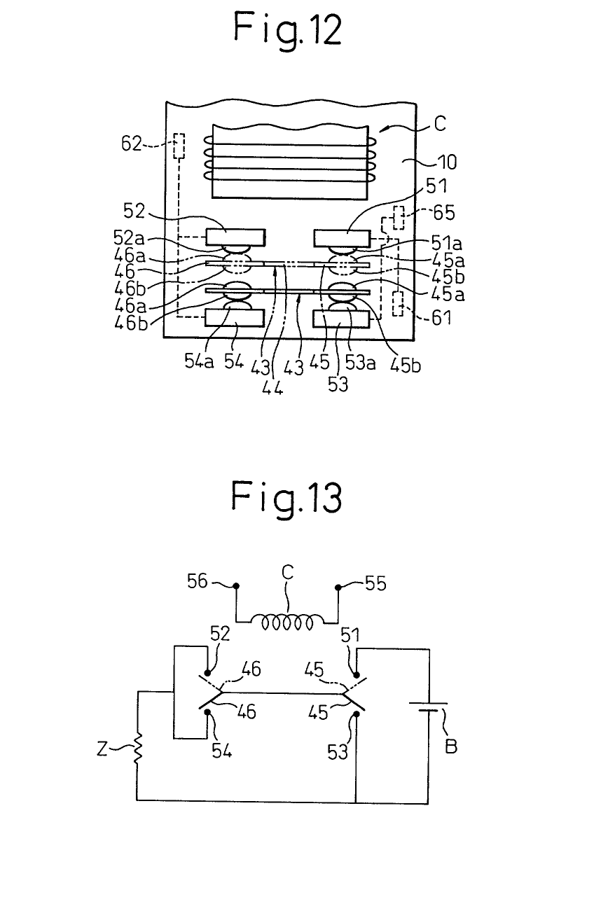

FIGS. 12 and 13 are a schematic view and a circuit diagram illustrating the operation like FIGS. 5 and 6 of the first embodiment. The electric current supplied to the load flows in the same manner as in the first embodiment.

As will be obvious from FIG. 8, the height of the contact elements 53a, 54a of the third fixed contact terminal 53 and of the fourth fixed contact terminal 54 from the base block is larger than the height of the contact elements 51a, 52a of the first fixed contact terminal 51 and of the second fixed contact terminal 52 from the base block. This is because the contact elements 45a, 46a of the first moving piece 45 and of the second moving piece 46 come into contact with the contact elements 51a, 52a of the first fixed contact terminal 51 and of the second fixed contact terminal 52 when the first moving piece 45 and the second moving piece 46 are directed downward nearly vertically, whereas the contact elements 45b, 46b of the first moving piece 45 and of the second moving piece 46 come into contact with the contact elements 53a, 54a of the third fixed contact terminal 53 and of the fourth fixed contact terminal 54 when the first moving piece 45 and the second moving piece 46 are tilted. Then, a stable contact is obtained between the contact elements, and the circuit can be reliably made and broken even for high voltages.

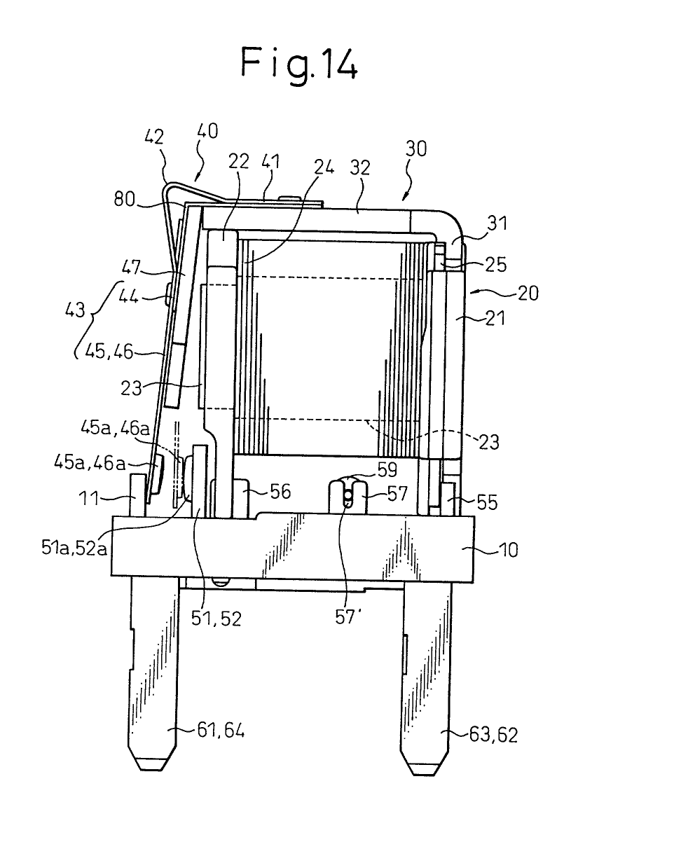

Next, described below is a third embodiment. FIG. 14 is a side view illustrating an electromagnetic relay of the third embodiment. In the third embodiment, in comparison with the first embodiment, an electrically insulating member 80 is interposed between the horizontal portion 32 of the yoke 30 and the horizontal portion 41 of the spring member 40, and between the hanging portion 43 of the spring member 40 and the armature 47. Therefore, the electric current is prevented from flowing into the yoke 30 and the armature 47; i.e., the current carrying portion decreases and less heat is generated. The armature 47 is attached to the hanging portion 43 of the spring member 40 by an electrically insulating fastening fitting.

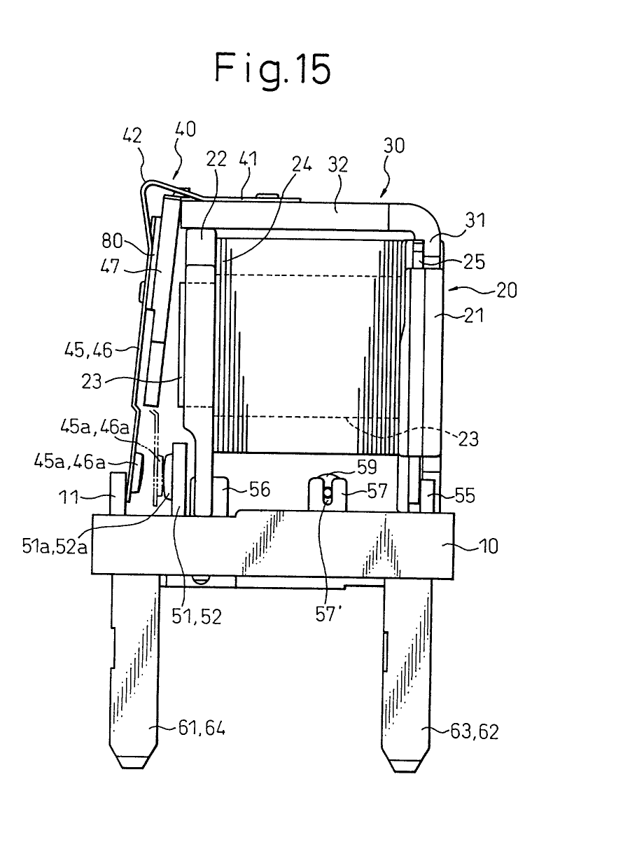

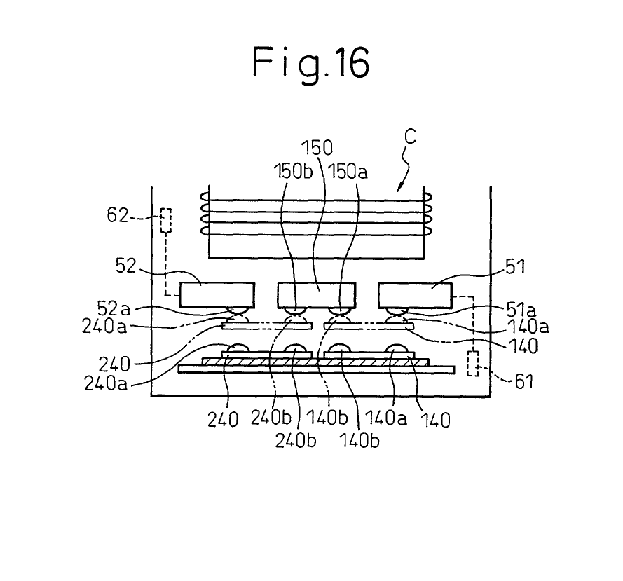

Next, described below is a fourth embodiment. FIG. 15 is a side view illustrating an electromagnetic relay of the fourth embodiment. In the fourth embodiment, in comparison with, the first embodiment, the hanging portion 43 of the spring member 40 is terminated nearly at the end of the armature 47, the electrically insulating member 80 is overlapped on the hanging portion 43, and a sub-hanging portion 43′ is overlapped on the electrically insulating member 80. Then, the hanging portion 43, the electrically insulating member 80 and the sub-hanging potion 43′ are all secured to the armature 47 by using an electrically insulating fastening fitting, and the lower side of the sub-hanging portion 43′ is branched into two to form the first moving piece 45 and the second moving contact 46. Therefore, the current carrying portion is further decreased to generate even less heat.

The third and fourth embodiments can be applied even to the second embodiment.

Next, described below is a fifth embodiment. In the fifth embodiment, a fixed conductor piece 150 is disposed between the first fixed contact terminal 51 and the second fixed contact terminal 52 of the first embodiment, and contact elements 150a and 150b are attached to near both ends of the fixed conductor piece 150. Further, a first separate moving piece 140 and a second separate moving piece 240 separated from each other through the insulating member 80 are attached to the hanging portion 43 of the spring member 40. The first separate moving piece 140 and the second separate moving piece 240 are branched into two, respectively. The first separate moving piece 140 has, attached thereto, a contact element 140a that comes in contact with the contact element 51a of the first fixed contact terminal 51 and a contact element 140b that comes in contact with the contact element 150a of the fixed conductor piece 150, and the second separate moving piece 240 has, attached thereto, a contact element 240a that comes in contact with the contact element 52a of the second fixed contact terminal 52 and a contact element 240b that comes in contact with the contact element 150b of the fixed conductor piece 150.

When the coil C is excited, therefore, an electric current flows through the first lead terminal 61; the first fixed contact terminal 51, the contact element 51a, the contact element 140a, the first separate moving piece 140, the contact element 140b, the contact element 150a, the fixed conductor piece 150, the contact element 150b, the contact element 240b, the second separate moving piece 240, the contact element 240a, the contact element 52a, the second fixed contact terminal 52 and the second lead terminal 62. Thus, the electric current flows through four contact sets, the time in which the arc continues is further shortened, and the resistance against the arc is further improved.

The fifth embodiment has dealt with the case where only one fixed conductor piece was used. Similarly, however, it is also allowable to increase the number of the fixed conductor pieces.

The effect of the serial arrangement is lost if the contact sets are closed and opened in a dispersed manner. It is therefore desired that the contact sets are so controlled as to be closed or opened all within a predetermined period of time, e.g., within 0.1 ms. Concretely speaking, this is done by controlling the spring constant of the spring member that is a material forming the moving conductor pieces.

This holds true even when there is no fixed conductor piece as in the first and second embodiments or even when there are many fixed conductor pieces.

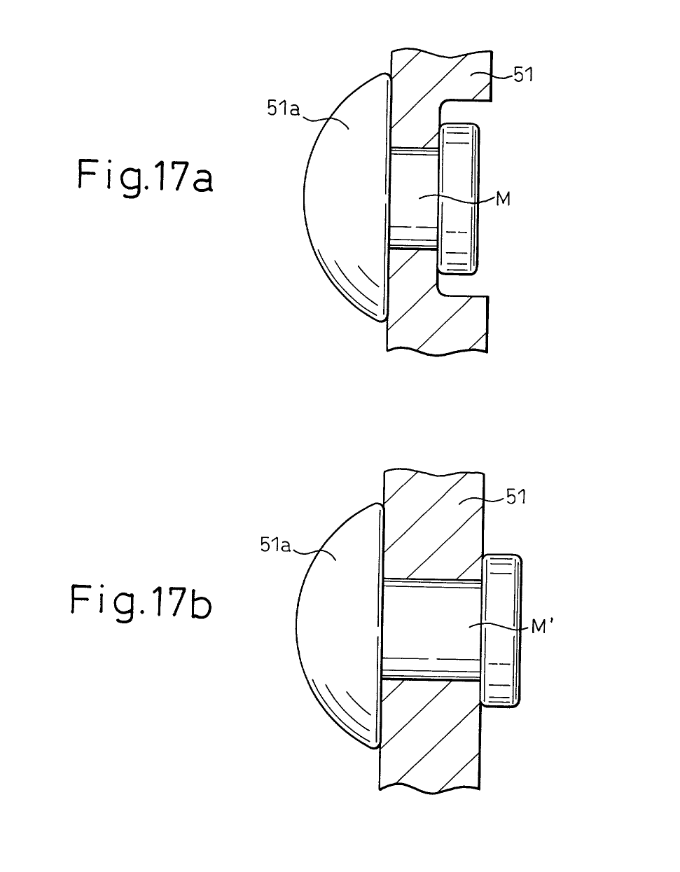

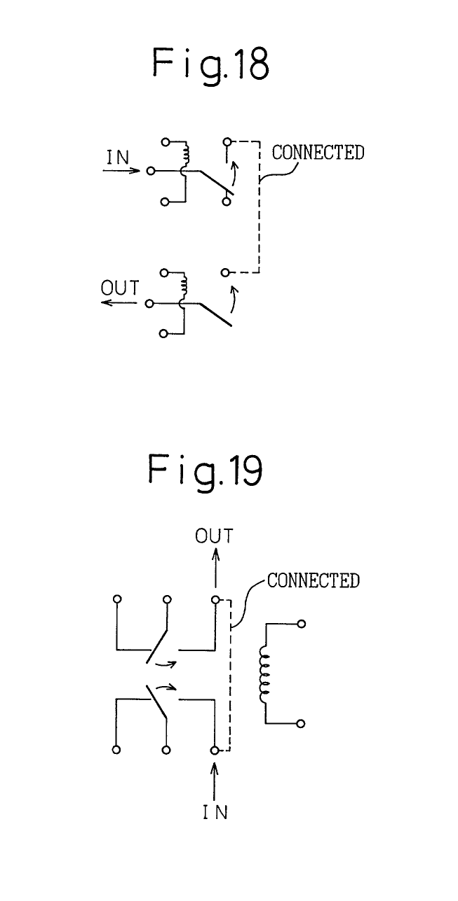

Next, described below is the attachment of the contact element to the first fixed contact terminal 51 in each of the embodiments. FIG. 17a is a diagram illustrating a portion of the first fixed contact terminal 51 of a decreased thickness to where the contact element 51a is caulked. FIG. 17b illustrates a conventional attachment. As will be obvious from the comparison of the two, an intermediate portion M of the contact element 51a in the embodiment of the invention is smaller than an intermediate portion M′ that is attached according to the prior art, and reduces the material cost.

1. An electromagnetic relay comprising:
a first fixed contact terminal and a second fixed contact terminal spaced from each other on one surface of a base block;
fixed conductor pieces of a number n−1 mounted on said one surface of said base block in alignment with and, between the first fixed contact terminal and the second fixed contact terminal; and
moving conductor pieces, in a number n, formed by or supported by cantilevered spring members that are simultaneously moved by one or plural coils mounted on said base block, for connecting the first fixed contact terminal, the second fixed contact terminal and the two neighboring fixed conductor pieces simultaneously in a crosslinked manner;
wherein the first fixed contact terminal and the second fixed contact terminal are connected together through serially arranged contact sets of a number 2n formed by the first fixed contact terminal, second fixed contact terminal, fixed conductor pieces of the number n−1 and moving conductor pieces of the number n;
while n is an integer of not smaller than 1.

2. An electromagnetic relay according to claim 1, wherein a third fixed contact terminal is provided facing the first fixed contact terminal with the moving conductor pieces sandwiched therebetween, and a fourth fixed contact terminal is provided facing the second fixed contact terminal with the moving conductor pieces sandwiched therebetween, the first fixed contact terminal serving as a make terminal, the third fixed contact terminal serving as a break terminal, and the second fixed contact terminal and the fourth fixed contact terminal conductive to each other serving as a common terminal.

3. An electromagnetic relay according to claim 1, wherein the number of the coils is one.

4. An electromagnetic relay according to claim 1, wherein the moving conductor pieces have a branched shape on the side on where they come in contact with the first fixed contact terminal, second fixed contact terminal and two neighboring fixed conductor pieces.

5. An electromagnetic relay according to claim 1, wherein the moving conductor pieces are supported by the spring member via an electrically insulating member.

6. An electromagnetic relay according to claim 1, wherein there is formed a stopper with which the moving conductor pieces come in contact to define their positions when the coil is not excited, the stopper being molded with a resin integrally with the base block.

7. An electromagnetic relay according to claim 1 or 2, wherein contact elements are attached by caulking to the portions of the first and second fixed contact terminals, of the third and fourth fixed contact terminals, of the fixed conductor pieces and of the moving conductor pieces that come in contact with one another, the contact elements protruding toward the contacting side, and the regions of the members to where the contact elements are caulked have a decreased thickness on the side on where the contact elements are caulked.

8. An electromagnetic relay according to claim 1 or 2, wherein the coil is one obtained by arranging an iron core on the inside of a cylindrical portion of a bobbin that has a plate portion and the cylindrical portion and by arranging a coiled conductor on the outer side of the cylindrical portion, the bobbin is secured to the base block with its plate portion being inserted in a hole formed in the base block and with its hook formed on the plate member being engaged with the base block, and the coiled conductor is connected to a terminal of the coil mounted on the base plate via a conductor member for coil, the conductor member for coil being insert-molded in the bobbin.

9. An electromagnetic relay according to claim 8, wherein the first and second fixed contact terminals or the third and fourth fixed contact terminals and coil terminals are formed by machining an electrically conducting plate member integrally with the lead terminals which protrude from the other surface of the base block and to which the external conductors are connected, and are, then, insert-molded in the base block.

10. An electromagnetic relay according to claim 9, wherein there are provided a pair of terminals each having a slot, and a protection element is mounted with its both ends being inserted in the pair of slots.

11. An electromagnetic relay according to claim 2, wherein:
contact elements are attached to the portions of the first and second fixed contact terminals, of the third and fourth fixed contact terminals, of the fixed conductor pieces and of the moving conductor pieces so as to protrude toward the side of the contact surface;
the angle of the moving conductor pieces, relative to the vertical line, when they come into contact with the first and second fixed contact terminals, is different from the angle of the moving contact pieces, relative to the vertical line, when they come into contact with the third and fourth fixed contact terminals;
the contact elements of the moving conductor pieces that come into contact with the contact elements of the first and second fixed contact terminals and the contact elements of the moving conductor pieces that come in contact with the contact elements of the third and fourth fixed contact terminals, are located at an equal distance from the center of movement of the moving pieces; and
a height of the contact elements of the third and fourth fixed contact terminals from the base block is different from a height of the contact elements of the first and second fixed contact terminals from the base block, so that the contact elements of the moving conductor pieces come in contact with the contact element of the first fixed contact terminal and with the contact element of the third fixed contact terminal at their centers and come in contact with the contact element of the second fixed contact terminal and with the contact element of the fourth fixed contact terminal at their centers.

12. An electromagnetic relay according to claim 1 or 2, wherein plural contact sets are closed and opened within a predetermined period of time.
